(19) United States
(12) Patent Application Publication
(10) Pub. No.: US 2011/0216306 A1
(43) Pub. Date: Sep. 8, 2011

(54) METHOD FOR DETERMINING THE FLOW OF A FLUID CLOSE TO A SURFACE OF AN OBJECT IMMERSED IN THE FLUID

(76) Inventor: Rudolf Rigler, St-Sulpice (CH)

(21) Appl. No.: 12/673,263

(22) PCT Filed: Aug. 13, 2008
(86) PCT No.: PCT/EP08/06671

§ 371 Date: May 25, 2011

Related U.S. Application Data
(60) Provisional application No. 60/935,454, filed on Aug. 14, 2007.

(51) Int. Cl. G01P 5/22; G01F 1/00

(52) U.S. Cl. 356/28; 356/27

(57) ABSTRACT

The invention relates to a Method for determining the flow of a fluid close to a surface of an object immersed in the fluid by analyzing at least one confocal measurement volume in the fluid, comprising the steps of: focusing light into the at least one confocal volume within the fluid; detecting and determining of at least one optical parameter of at least one particle comprised in the confocal volume; and determining the flow velocity of the fluid based on the determination of the at least one optical parameter using a correlation function, in particular an auto correlation function or a cross correlation function. Furthermore, the invention relates to an object immersed in a fluid and comprising a measuring device for carrying out the method.

The analysis of laminar and turbulent aerodynamic flow around objects of different size and shape usually involves seeding and laser velocimetry. This technology is well developed and constitutes a widely used standard.

Many properties known from airplane design like wings and rudder etc. have their counterpart in boat building i.e the keel can be envisaged as a wino turned by 90 degrees and basic properties can be transferred from aerodynamics to nautical design including analysis of laminar and turbulent flow. In principle seeding and laser velocimetry are possible also in the aqueous phase however fluctuations in densities and refractive index of water will set a limit. Contrary to the analysis of the real size object (airplane) the corresponding case in aqueous phase (ship) is extremely demanding and costly.

This invention proposes a method which is able to follow laminar flow of aqueous phases and their change into a turbulent regime close to the surface of immersed objects. It is based on the detection of fluorescent particles normally found in seawater and the correlation of their intensities in time and space.

The concept is based on a technology developed at the Karolinska Institutet by Rigler and collaborators which enables the analysis of molecules and particles emitting photons (Fluorescence Correlatons Spectrocopy, FCS, Rigler and Elson, 2000). The basic concept is to follow the photon emission of particles in a small volume element of light which excites the particles (molecules) to fluorescence. The flow of particles will cause fluctuations of the emitted light which are correlated in time and space.

The measurement of flow velocities with single point illumination has been described in solutions (Magde et al. 1977), as well as for micro channels (Gösch et al. 2000). With the development of confocal epi illumination (Rigler et al. 1993) ultimate sensitivity was reached and the flow of single molecules in microchannels was performed (Gösch et al. 2000).

It is known how to measure the flow of a fluid surrounding an object immersed in the fluid, e.g. a boat in water driven by at least one propeller which is arranged on the outside of the boat in the water. The arrangement involves laser Doppler or acoustic Doppler analysis. In this respect the flow is accomplished by the movement of the driven boat relative to the water and the flow measurement is intended to determine the velocity of the moving boat. Velocity measurements with a propeller leads to a loss of velocity of the boat, as the propeller produces additional resistance in the water outside of an optimal streamline form. Laser and acoustic Doppler analysis are rather costly.

Therefore, it is the object of the invention to find a method which allows to determine the flow along an immersed object, in particular for optimizing the streamline form and skin of the object and furthermore for determining the velocity of the object relative to the fluid.

According to the invention there is proposed a method for determining the flow of a fluid close to a surface of an object immersed in the fluid by analyzing at least one confocal measurement volume in the fluid, comprising the steps of:

focusing light into the at least one confocal volume within the fluid;
detecting and determining of at least one optical parameter of at least one particle comprised in the confocal volume; and
determining the flow velocity of the fluid based on the determination of the at least one optical parameter using a correlation function, in particular an auto correlation function or a cross correlation function.

Preferably the optical parameter is the luminescence of at least one particle in the confocal volume, which is measured by Fluorescence Correlation Spectroscopy FCS, wherein the following steps are comprised:

exciting the at least one luminescent particle in the at least one confocal volume, imaging the confocal volume on detecting means for detecting the intensity fluctuation of luminescent emission of the particle,
recording of the luminescent intensity by the detecting means,
determining the flow velocity based on a correlation function, in particular an auto correlation function or a cross correlation function, depending from the recorded luminescent intensity.

Alternatively or additionally the optical parameter may be the reflexion of at least one particle in the confocal volume, wherein the following steps are comprised:

irradiating the at least one particle in the at least one confocal volume, imaging the confocal volume on detecting means for detecting the reflexion intensity of reflected light from of the particle,
recording of the reflexion intensity by the detecting means,
determining the flow velocity based on a correlation function, in particular an auto correlation function or a cross correlation function, depending from the recorded reflexion intensity.

At last the optical parameter may be the scattering light of at least one particle in the confocal volume, wherein the following steps are comprised:

irradiating the at least one particle in the at least one confocal volume, imaging the confocal volume on detecting means for detecting the scattering intensity of light incident on the particle,
recording of the scattering intensity by the detecting means,
determining the flow velocity based on a correlation function, in particular an auto correlation function or a cross correlation function, depending from the recorded scattering intensity.

Preferably the flow and its direction are evaluated from correlated luminescence intensities emitted by at least one particle in each of two adjacent confocal volumes.

It is proposed that the flow and its direction are evaluated from correlated reflexion intensities emitted by at least one particle in each of two adjacent confocal volumes.

Alternatively the flow and its direction are evaluated from correlated scattering intensities emitted by at least one particle in each of two adjacent confocal volumes.

A distance between the adjacent confocal volumes is preferably chosen depending on the velocity range of interest, the distance being from about 100 μm to about 10000 μm.

The at least one particle may be naturally contained in and/or man-made put into the fluid.

Preferably the immersed object is a boat and the surface comprises immersed parts of this boat, in particular its hull, keel or rudder.

Preferably the method is carried out in a fluid which is seawater or freshwater or brackish water.

Preferably the determination of the flow velocity is based on one confocal volume for a desired velocity range up to 0.1 m/s.

For a higher velocity the determination of the flow velocity is based on two adjacent confocal volumes for a desired velocity range from >0.1 m/s to 50 m/s.

For carrying out the proposed measurements it is preferred that the particles are organic particles, in particular plankton and/or algae or derivatives of algae and/or pigments, or inorganic particles. These particles can be found naturally in the fluid, in particular in sea water.

Preferably the confocal volumes have a size in the range of 10-15 (Femto) to 10-9 (Nano) liters.

In order to be able to measure the flow close to the immersed surface of the object, it is proposed that a distance between a confocal volume and the surface of the immersed object is chosen in the range from zero to few centimeters.

Furthermore the determined flow may be used to determine the velocity of the immersed object, when the immersed object is propelled within the fluid by an additional force, in particular wind force and/or motor force. In this respect it has to be mentioned, that the flow close to the immersed surface of the object is a result of a relative movement between the object and the surrounding fluid, in particular between the boat and the sea water.

The light which is focused on the at least one confocal volume is preferably a laser light.

The proposed method gives the possibility to systematically examine the flow of fluid around an object immersed in this fluid. From the determination results there can be derived detailed information about laminar or turbulent flow characteristics or about cavitation along the surface of the object, especially in a range very close to this surface. Furthermore, this method can be used for determining the velocity of the object itself relative to the surrounding fluid.

Assuming that the particles are man-made put into the fluid, e.g. the sea, it is possible to track the distribution of these particles over long distances and long time, which leads to the possibility to determine the flow in a wide sea area, e.g. the Baltic sea, the Mediterranean. This enables to calculate flow models of the sea and to derive flow maps for certain sea areas. The man-made particles comprise preferably a combination of at least two particles emitting different colors, which can then be determined by dual color cross correlation or by higher order cross correlation in case of multicolor particles. If the particles are made from at least two particles with know different luminescences, these particles can be found and determined easily in the fluid, even if the particles have traveled a great distance within the fluid. This sort of particles is especially suitable for the determination of flow characteristics in a greater sea area, as described above.

According to another aspect, there is proposed an object, preferably boat; immersed in a fluid and comprising a measurement device for carrying out the method according to the invention, wherein the device comprises:

at least one light source, preferably laser light source, which delivers a light beam for irradiation of at least one confocal volume;
at least one lens arrangement for defining the confocal volume in the fluid; and
at least one lens arrangement for imaging the confocal volume to a photo detector, preferably photo diode.

Preferably the lens arrangement for defining the confocal volume and the lens arrangement for imaging are configured by the same lens or the same lenses. The two lens arrangements are then in fact one single lens arrangement, which is used for focusing as well as for imaging the confocal volume.

The measurement device may comprising at least one first glass fiber cable segment, which is arranged in the optical path between the light source and the lens arrangement for defining the confocal volume.

The at least one first glass fiber cable segment may be further optically connected to the lens arrangement for imaging the confocal volume, in particular for collecting the emission or reflection or scattering from the confocal volume.

Preferably the measurement device comprises at least one second glass fiber cable segment, which is arranged in the optical path from the lens arrangement to the photo detector.

The measurement device may further comprise a dichroic beam splitter, which is arranged between the lens arrangement and the light source and between the lens arrangement and the photo detector.

It is proposed that the first glass fiber cable segment is optically connected between the dichroic beam splitter and the lens arrangement, and the second glass fiber cable segment is optically connected between the dichroic beam splitter and the photo diode.

Preferably the photo detector is an avalanche photo diode.

For the determination of the flow and its direction it is proposed that the device comprises two lens arrangements for defining two confocal volumes in the fluid and two lens arrangements for imaging both confocal volumes to a photo detector.

Preferably the device is mounted on the immersed object, preferably a boat.

In order to be able to define the confocal volume in the fluid, the at least one lens arrangement for defining the confocal volume in the fluid is arranged on or in the surface of the immersed object such that the confocal volume can be produced close to the immersed surface of the object. This can be achieved for example by a small opening in the surface of the object, in which a lens of the lens arrangement is inserted.

Further details of the invention will be described in the following text and figures. There is described a preferred embodiment using Fluorescence Correlations Spectroscopy (FCS) for carrying out the method according to the invention.

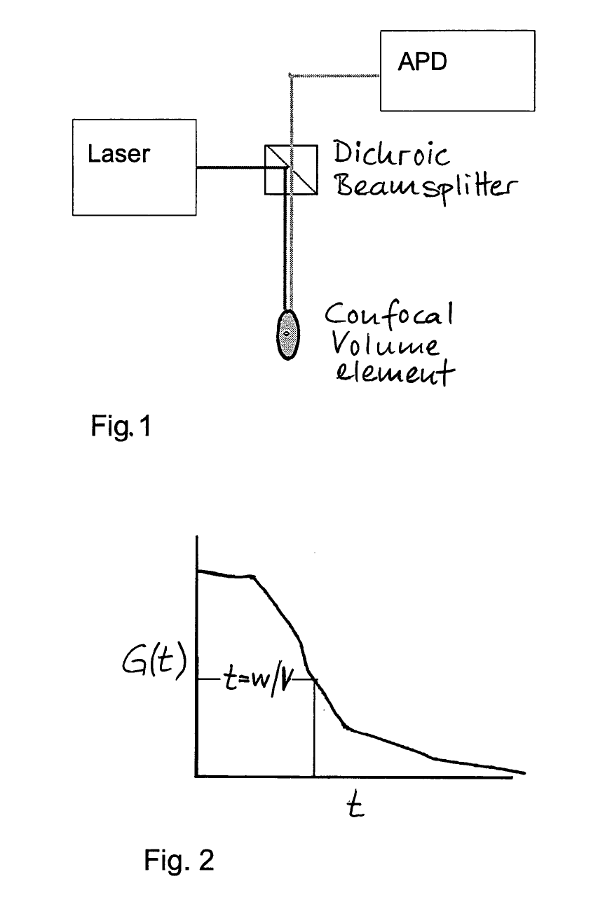

FIG. 1 shows in a schematic way the arrangement for the irradiation of one confocal volume in the fluid, i.e. a setup for single point illumination with laserdiode and avalanche photo diode (APD)

From the intensity fluctuations as observed by a single photon detector the flow velocities can be determined from the autocorrelation function G(t).

The correlation function is related to the fluctuation intensity I(t) by:

$$\begin{matrix}{G}_{1} ( τ ) = \frac{〈 I ( t ) I ( t + τ ) 〉}{{I}^{2}} & ( 1 ) \\ {G}_{1} ( τ ) = \frac{1}{N} \frac{1}{1 + \frac{τ}{{τ}_{D}}} exp - ( \frac{{V}^{2} {τ}^{2}}{{ω}^{2}} \frac{1}{1 + \frac{τ}{{τ}_{D}}} ) & ( 2 )\end{matrix}$$

Here:

1/N=number of particles in confocal volume element
V=flow velocity
ω=radius of confocal element
τ_{D}=diffusion time

For a radius ω of 1 μm and a velocity V of 1 m/s=1 μm/1 μs the characteristic flow time is

τ_{flow}=ω/V=1 μs

FIG. 2 shows the autocorrelation of flow velocity.

With decreasing flow velocity the diffusion processes as characterised by the diffusion time τ_{D} will dominate the correlation function. The diffusion time τ_{D}=ω²/4D (D=diffusion constant [6×10⁻⁶ cm²/s for a dye molecule] and with ω=1 μm τ_{D} is ca 200 μs which is orders of magnitude lower than the flow time.

The flow speed as well as its direction can be evaluated from the correlated fluorescence intensities emitted by particles in two adjacent points of illuminations. In this case the probability of a particle being at point 2 is compared with its probability of being in point 1 which is related to the time the particles takes to travel from point 1 to point 2.

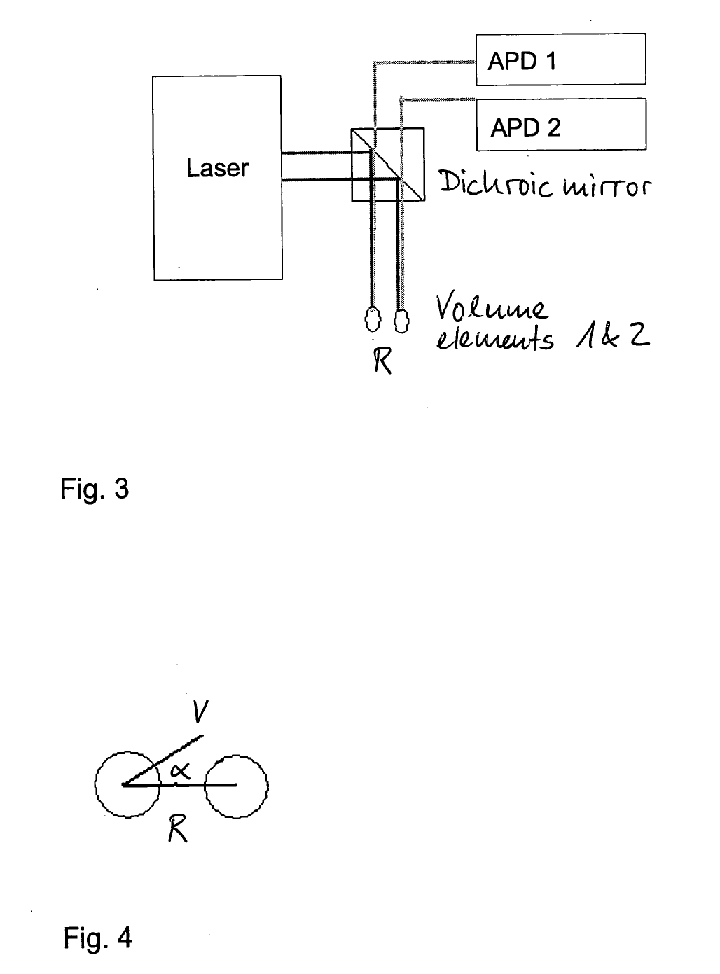

The setup contains 2 excitation points excited with the laser diode and the emission is detected from the 2 excitation points (FIG. 3). FIG. 3 shows a set up for two spot excitation and detection by 2 APDs.

For this case the correlation function G₂(t) is given:

$$\begin{matrix}{G}_{2} ( τ ) = \frac{〈 {I}_{1} ( t ) {I}_{2} ( t + τ ) 〉}{{I}_{1} {I}^{2}} \\ and & ( 3 ) \\ {G}_{2} ( τ ) = 1 + \frac{1}{N} exp - ( \frac{{( V τ - R )}^{2}}{{ω}^{2}} ) & ( 4 )\end{matrix}$$

As can bee seen R is the distance between the excitation points and V the velocity along the direction of R. If R goes to zero both points superimpose and equation (4) collapses to equation (2).

Most importantly the component of V at the angle α to the direction of R can be calculated according to Brinkmeier (1996) and Brinkmeier and Rigler (1995):

$${G}_{2} ( τ ) = 1 + \frac{1}{N} exp - \frac{{R}^{2}}{{ω}^{2}} ( \frac{{τ}^{2}}{{τ}_{F}^{2}} + 1 - 2 \frac{τ}{{τ}_{F}} cos α ) \qquad ( 5 )$$

With

τ_{F}=R/V flow time over interfocal distance
α=angle between V and R (see FIG. 4)

As can be seen from equation (4) G₂(τ) goes through a maximum which is positioned in relation to the distance R. Basically from the position of the maximum on the time axis and the amplitude of G₂(τ) the value of V and the angle α can be estimated.

The speeds of interest will be between 0.1 to 50 m/s correspondent to about 0.2 to 100 knots. While at slow speeds single spot measurements are preferable (With a focal radius of 1 μm at a speed 0.1 m/s the flowtime τ_{F}=10 μs) while for high speeds the 2 focal measurement will be preferable. Depending on the velocity range of interest the interfocal distance R is chosen. With a distance R of 100 μm at V of 10 m/s a characteristic flow time τ_{F}=R/V of 10 μs is obtained. At this time (10 μs) the peak of G₂(τ) will be observed. The width of the Gaussian will depend on the ratio R/ω.

TABLE 1
Characteristic flow time for 1 and 2 spot measurements and different flow
velocities.

| Measurement | Velocity [m/s] | R [μm] | w [μm] | Flowtime [μs] |
|---|---|---|---|---|
| Single spot | 0.1 | | 1 | 10 |
| Two spot | 10 | 100 | 1 | 10 |
| | 10 | 200 | 1 | 20 |
| | 20 | 200 | 1 | 10 |
| | 20 | 2000 | 1 | 100 |

In order to test the feasibility of this approach there were carried out single spot measurements in tap water as well as in sea water.

It was first discovered that Stockholm tap water contained measurable contamination of molecules/particles emitting in the red when excitation with a Neon laser (633 nm) was used. Similarly contaminants emitting in the green were found when excitation with an Argon laser (488 nm) was used.

The fluorescence signal of tap water was measured both in a flow setup and on a droplet in a Zeiss-Confocor 2 (FCS spectrometer). The aim was to study whether tap water contains fluorescence molecules that can be used for monitoring flow velocity in a future project. The result shows that tap water is contaminated with both red and green fluorescence molecules. In the graph beneath the G₁(τ) is shown for tap water together with the trace of the fluctuating signal of the streaming tap water. As is visible from the graph red emitting contamination with a flowtime of 49 μs and a concentration of about ca 3 10⁻⁸M was detected. As comparison double distilled and membrane filtered water was used and no correlation could be detected.

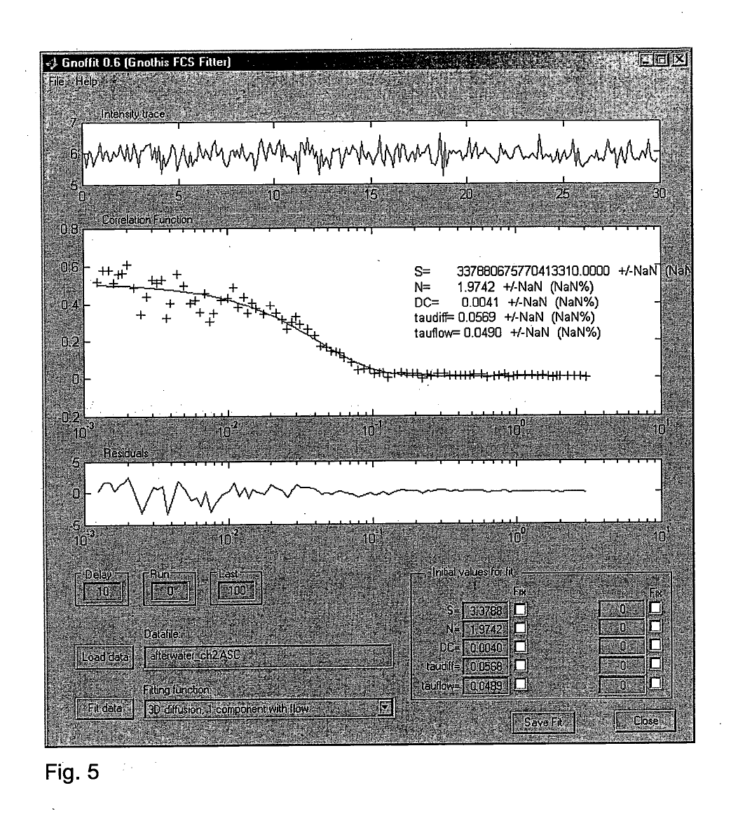

FIG. 5 shows FCS measurement and G₁(τ) of tap water in flow. Correlation is visible, which indicates presence of fluorescence particles in the water.

The existence of measurable molecules is demonstrated in FIG. 5 where the signal of individual contaminating molecules is shown

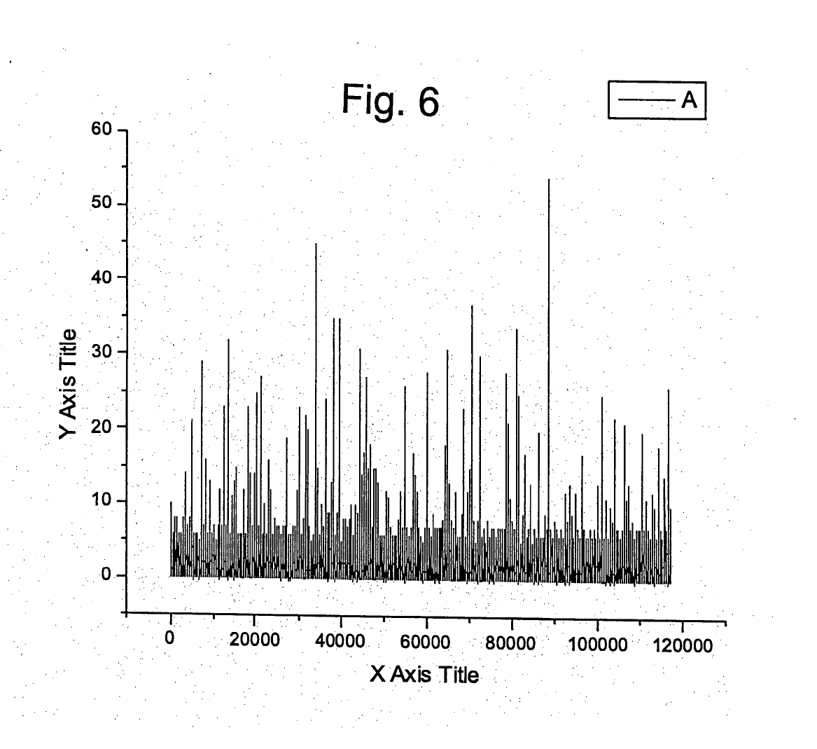

FIG. 6 shows an intensity trace of tap water in flow. Data shows presence of many fluorescence molecule peaks.

The distilled water showed a much reduced contamination (FIG. 6)

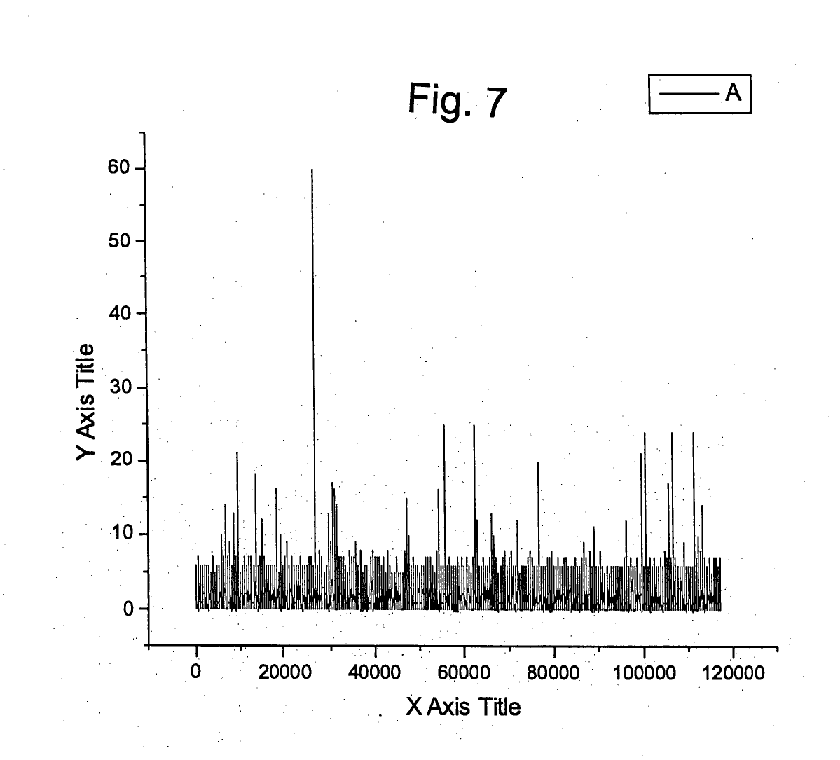

FIG. 7 shows an intensity trace of buffer in flow before tap water is introduced into the system. A few fluorescence molecule peaks are visible.

### Fluorescence Signal in Sea Water

The red fluorescence signal of seawater from three different places in the Stockholm archipelago was measured in a flow setup and on a “lying” droplet. The aim was to study whether seawater contains fluorescence molecules that can be used for flow velocity measurements in a future project. The result shows that seawater is very contaminated with red fluorescence molecules. Green signal was not evaluated here. Data from Confocor2 measurements are available but not evaluated.

Sea water was collected at Sandhamn brygga, Rosättra brygga and Sandhamn Trouville.

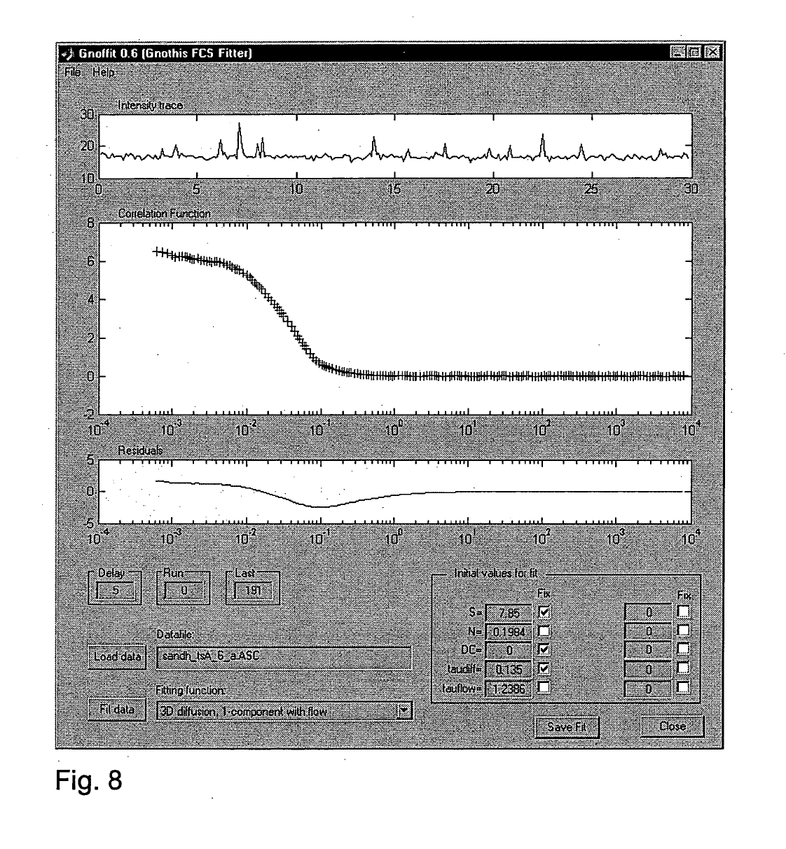

FIG. 8 shows FCS measurement and G₁(τ) of seawater in 6 l/min flow. Correlation is visible, which indicates presence of fluorescence particles in the water.

TABLE 2
Concentration of fluorescent particles excited at 633 nm and emitting above
680 nm

| | Number of | |
|---|---|---|
| Position of sea | contaminants in | Concentration of |
| water samples | volume element of | fluorescent contaminants |
| taken | observation | [nM] |
| Sandhamns brygga | 2.7 | 40.5 |
| Sandhamn | 3.6 | 54 |
| Trouville | | |
| Rosättra brygga | 3.2 | 48 |
| Tap water | 0.5 | 7.5 |
| Distilled water | 0.06 | 0.93 |

The conclusion from this observation is that a heavy contamination by fluorescent molecules exist at least in the Baltic sea. It is assumed that the contamination in the Mediterranean sea is at least of the same magnitude as the Baltic sea.

### Construction of the One Spot and Two Spot Measurement Setup for Hydrodynamic Analysis

The setup, which is preferably used, consists of a single mode or multimode glasfiber coupled to a red diode laser (pigtail laser diode) which delivers the excitation radiation to the excitation spot. From the excitation spot the emission will be collected from the same cable and will be transmitted to a glasfiber linked avalanche photo diode (APD). Introducing a dichroic beam splitter separates excitation intensity from the emitted intensity which is transferred to the detectors (see FIG. 1). The volume element defined by a focal lens at the end of the glasfiber cable will lie close to the fiber end.

The double illumination setup uses one diode laser but 2 APDs as seen in FIG. 2.

### Boatspeed Vs Laminar and Turbulent Flow

The fiber based setup ensures transmission of laser excitation and detection of emitted radiation over long distances >10 m and lends itself to the construction of multiple measuring points which can be freely chosen on the ship's hull, keel and rudder.

In order to obtain a high boat speed, laminar flow around the immersed parts of the boat is required and turbulence and cavitation is to be avoided as much as possible.

It was observed in laminar flow in microchannels (Goesch et al. 2000) that the flow exhibits a parabolic flow profile with flow velocity close to zero at the microchannel wall and with a maximum in the middle of the channel.

The nearest water layers stick to the hull surface with zero velocity and following layers will flow in relation to the boat speed. An important application of the proposed method is to find out where the laminar flow profile will turn into turbulent flow and even cavitation. This occurs for example in the back part of the hull and in particular at the rudder at certain steering angles.

Test of Boat Models in Tanks with Streaming Water

In order to test the proposed method a test system includes ship models with laser, fiber guides, detectors and power supplies mounted atop. The data is transmitted to computer outside of the tank.

The main task is to test the principle behaviour of one spot and two spot detection as a function of flow speed in various layers around the model. Another task is to characterize the transition from laminar to turbulent flow. The measuring points are arranged such that the measuring focus can be placed in different water layers around the model by translation of the detection focus orthogonal to the surface.

A) Test of Flow Speed, Laminar and Turbulent Flow with a Mock Up Rudder Mounted on a Boat Hull

The measuring system containing measuring points on either side of the mock up rudder is set up in a way that lasers and detectors as well as the data analysis is placed in the boat hull. Analysis is carried out in sea water as a function of boat speed and boat performance on tack and down wind.

The mock up rudder is constructed such that the measuring point can be positioned at various locations on the rudder surface

### B) Test of Laminar and Turbulent Flow at the Keel Bulb

The equipment is used to test strategic points at the keel bulb and the winglets respectively. The detection/measuring points are placed at chosen points connecting the laser source, detectors and data analysis in the boat.

C) Test of Multiple Point Measuring Equipment at Places Selected from Previous Tests (Rudder)

This test develops the ultimate position of the measuring points at the rudder as well as software and indicators for the boat crew when unfavourable conditions in terms of boat speed and hydrodynamic behaviour are emerging. The indicators should also contain instructions for improving and optimizing the boat behaviour.

### REFERENCES

Magde, D, Elson, W.&Webb. W. W. (1977). Flow analysis by FCS. Biopolymers
Rigler, R, Mets, U., Widengren, J. & Kask, P. (1993): Fluorescence correlation spectroscopy with high count rate and low background: Analysis of translational diffusion. Eur. Biophys J, 22:169-175.
Brinkmeier, M and Rigler, R, (1995) Flow Analysis by means of Fluorescence Correlation Spectroscopy. Exp. Techn. Phys. 41,205-210
Brinkmeier, M. (1996) Fluoreszenz Korrelations Spektrosokopie in Mikrostrukturen. Dissertation Universität Braunschweig
Rigler, R. and Elson, E. (2000) Fluorescence Correlation Spectroscopy. Theory and Application. Springer-Verlag Heidelberg
Gösch, M., Blom, H., Holm, J. Heino, T.& Rigler, R. (2000) Hydrodynamic Flow Profiling in Microchannel structures by Single Molecule Fluorescence Correlation Spectroscopy. Anal. Chem. 72.3260-3265

1-26. (canceled)

27. Method for determining the flow of water, in particular seawater or freshwater or brackwater, close to a surface of a boat immersed in the water by analyzing at least one confocal measurement volume in the water, comprising the steps of:
focusing light into the at least one confocal volume within the water; detecting and determining the luminescence of at least one particle comprised in the confocal volume, which is measured by Fluorescence Correlation Spectroscopy FCS; and
determining the flow velocity of the water along the object immersed in water, preferably along parts of a boat, in particular its hull, keel or rudder, based on the determination of the luminescence using a correlation function, in particular an auto correlation function or a cross correlation function.

28. Method according to claim 27, wherein the following steps are comprised:
exciting the at least one luminescent particle in the at least one confocal volume, imaging the confocal volume on detecting means for detecting the intensity fluctuation of luminescent emission of the particle,
recording of the luminescent intensity by the detecting means, determining the flow velocity based on a correlation function, in particular an auto correlation function or a cross correlation function, depending from the recorded luminescent intensity.

29. Method for determining the flow of water, in particular seawater or freshwater or brackwater, close to a surface of an object immersed in the water by analyzing at least one confocal measurement volume in the water, comprising the steps of:
focusing light into the at least one confocal volume within the water; detecting and determining the reflexion of at least one particle in the confocal volume, wherein the following steps are comprised:
irradiating the at least one particle in the at least one confocal volume, imaging the confocal volume on detecting means for detecting the reflexion intensity of reflected light from of the particle, recording of the reflexion intensity by the detecting means,
determining the flow velocity of the water along the object immersed in water, preferably along parts of a boat, in particular its hull, keel or rudder, based on a correlation function, in particular an auto correlation function or a cross correlation function, depending from the recorded reflexion intensity.

30. Method according to claim 27, wherein the flow and its direction are evaluated from correlated luminescence intensities emitted by at least one particle in each of two adjacent confocal volumes.

31. Method according to claim 27, wherein the flow and its direction are evaluated from correlated reflexion intensities emitted by at least one particle in each of two adjacent confocal volumes.

32. Method according to claim 30 wherein a distance between the adjacent confocal volumes is chosen depending on the velocity range of interest, the distance being from about 100 μm to about 10000 μm.

33. Method according to claim 27, wherein the at least one particle is naturally contained in and/or man-made put into the water.

34. Method according to claim 33, wherein the man-made particle comprises a combination of at least two particles emitting different colors.

35. Method according to claim 34, wherein the flow is determined by dual color cross correlation or by higher order cross correlation.

36. Method according to 27, wherein the determination of the flow velocity is based on one confocal volume for a desired velocity range up to 0.1 mls.

37. Method according to claim 27, wherein the determination of the flow velocity is based on two adjacent confocal volumes for a desired velocity range from >0.1 m/s to 50 m/s.

38. Method according claim 27, wherein the particles are organic particles, in particular plankton and/or algae or derivatives of algae and/or pigments, or inorganic particles.

39. Method according to claim 27, wherein the confocal volumes have a size in the range of (Femto) to lou9(Nano) liters.

40. Method according to claim 27, wherein a distance between a confocal volume and the surface of the immersed object is chosen in the range from zero to few centimeters.

41. Method according to claim 27, wherein the determined flow is used to determine the velocity of the immersed object, when the immersed object is propelled within the fluid by an additional force, in particular wind force and/or motor force.

42. Method according to claim 27, wherein the light which is focused on the at least one confocal volume is a laser light.

43. Object, preferably boat, immersed in water, in particular seawater or freshwater or brackwater, and comprising a measurement device for carrying out the method of claim 27, wherein the measurement device comprises:
at least one light source, preferably laser light source, which delivers a light beam for irradiation of at least one confocal volume;
at least one lens arrangement for defining the confocal volume in the fluid; and
at least one lens arrangement for imaging the confocal volume to a photo detector, preferably photo diode,
wherein the at least one lens arrangement of the measurement device for defining the confocal volume in the fluid is arranged on or in the surface of the immersed object, preferably boat, in particular on or in its hull, keel or rudder, such that the confocal volume can be produced close to the immersed surface of the object, preferably boat.

44. Object according to claim 43, wherein the lens arrangement for defining the confocal volume and the lens arrangement for imaging are configured by the same lens or the same lenses.

45. Object according to claim 44, further comprising at least one first glass fiber cable segment, which is arranged in the optical path between the light source and the lens arrangement for defining the confocal volume.

46. Object according to claim 45, wherein the at least one first glass fiber cable segment is further optically connected to the lens arrangement for imaging the confocal volume, in particular for collecting the emission or reflection or scattering from the confocal volume.

47. Object according to claim 46, further comprising at least one second glass fiber cable segment, which is arranged in the optical path from the lens arrangement to the photo detector.

48. Object according to claim 47, further comprising a dichroic beam splitter, which is arranged between the lens arrangement and the light source and between the lens arrangement and the photo detector.

49. Object according to claim 48, wherein the first glass fiber cable segment is optically connected between the dichroic beam splitter and the lens arrangement, and the second glass fiber cable segment is optically connected between the dichroic beam splitter and the photo diode.

50. Object according to claim 43, wherein the photo detector is an avalanche photo diode.

51. Object according to claim 43, wherein the device comprises two lens arrangements for defining two confocal volumes in the fluid and two lens arrangements for imaging both confocal volumes to a photo detector.

52. Object according to claim 43, wherein the device is mounted on the immersed boat.
